(19) United States
(12) Patent Application Publication
(10) Pub. No.: US 2026/0167386 A1
(43) Pub. Date: Jun. 18, 2026

(54) Electronic Equipment Holding and Mounting Assembly

(71) Applicant: Steven Strait, Panorama City, CA (US)

(72) Inventor: Steven Strait, Panorama City, CA (US)

(21) Appl. No.: 18/978,693

(22) Filed: Dec. 12, 2024

(51) Int. Cl. B65D 25/20; B65D 81/26; B65D 85/68; H04R 1/02

(52) U.S. Cl. CPC B65D 25/20; B65D 81/263; B65D 85/68; H04R 1/02; B65D 2585/6835

(57) ABSTRACT

An equipment holding and mounting assembly. The equipment holding and mounting assembly includes a base assembly with an inner volume designed to receive the equipment, and an upper containment structure designed to fit flush on the top of the base assembly to contain the equipment therein. The holding and mounting assembly includes sloped sides and curvatures to match particular equipment for use with the assembly. The holding and mounting assembly also includes bottom side attachment mechanisms for securing the holding and mounting assembly to other structures, e.g., equipment racks and/or shelving.

### FIELD OF THE INVENTION

This invention relates to equipment holding and mounting assemblies, including holding and mounting assemblies for electronic equipment.

### BACKGROUND

Electronic equipment, e.g., electronic audio equipment used for live musical events, is oftentimes mounted into an equipment rack and/or onto shelving to secure the equipment safety for transportation and use.

However, some particular equipment may not include the mounting mechanisms (e.g., rack ears, screw holes, etc.) necessary to rack mount the equipment. The equipment also may not be formed as a standard racking unit.

Accordingly, there is a need for an equipment holding and mounting assembly for such equipment.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows aspects of an equipment holding and mounting assembly according to exemplary embodiments hereof;

FIG. 2 shows side and top views of an equipment holding and mounting assembly according to exemplary embodiments hereof;

FIG. 3 shows an exploded view of an equipment holding and mounting assembly according to exemplary embodiments hereof;

FIG. 4 shows equipment being configured with a holding and mounting assembly according to exemplary embodiments hereof;

FIGS. 5-7 show aspects of equipment configured with an equipment holding and mounting assembly according to exemplary embodiments hereof;

FIG. 8 shows a side view of equipment and of an equipment holding and mounting assembly according to exemplary embodiments hereof;

FIG. 9 shows a rear perspective view of equipment and of an equipment holding and mounting assembly according to exemplary embodiments hereof;

FIG. 10 shows aspects of equipment according to exemplary embodiments hereof; and

FIGS. 11-13 shows mounting aspects of an equipment holding and mounting assembly according to exemplary embodiments hereof.

### DETAILED DESCRIPTION OF EXEMPLARY EMBODIMENTS

In general, the equipment holding and mounting assembly according to exemplary embodiments hereof includes an assembly for supporting and facilitating the configuration of electronic equipment with other types of structures, e.g., with equipment racks or shelves. For instance, some electronic equipment may lack adequate fastening mechanisms (e.g., rack ears, screw holes, etc.) to be rack mountable, and as such, may require modification(s) that may be time consuming, costly, and overall inconvenient. The inventive holding and mounting assembly described herein is designed to provide racking capabilities to such equipment. For example, in some embodiments, the electronic equipment may be attached to the holding and mounting assembly which may then be attachable to the equipment rack.

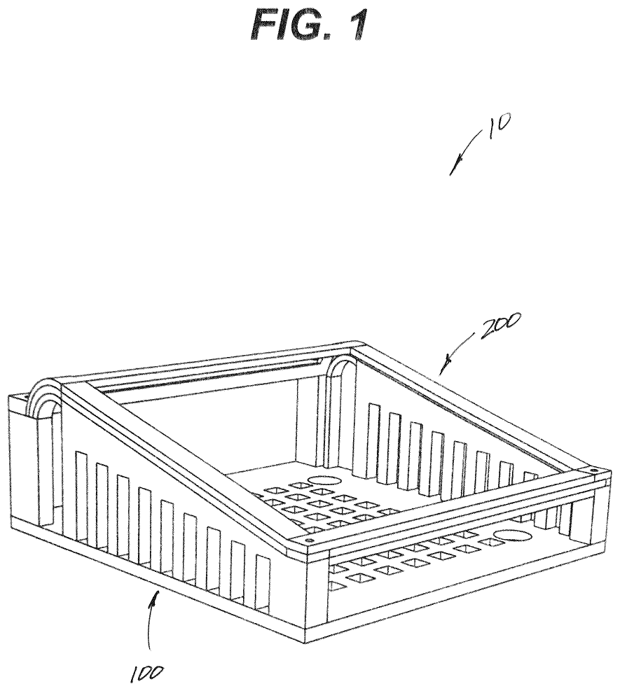

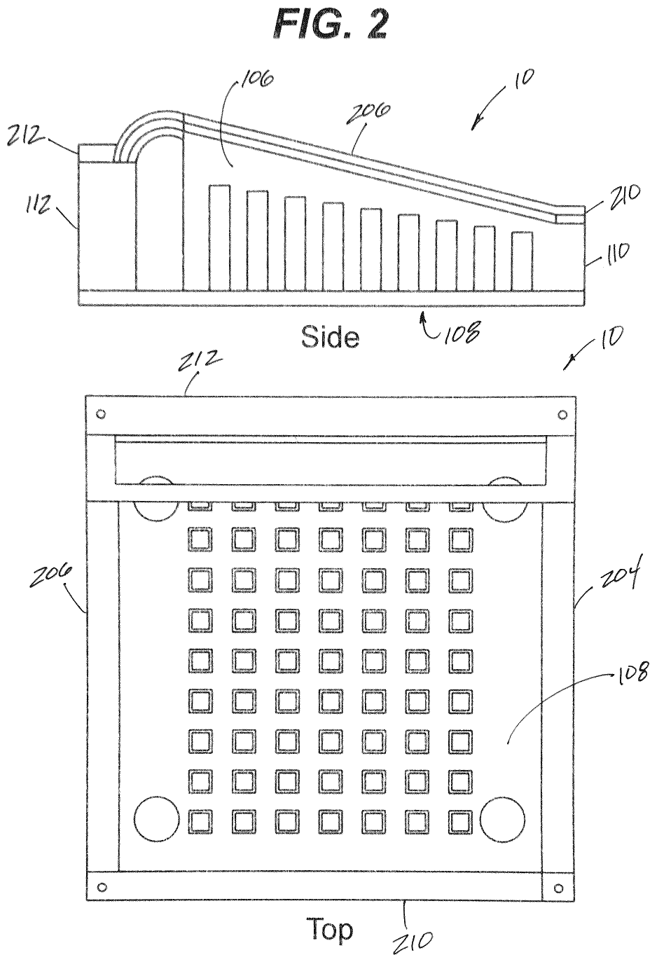

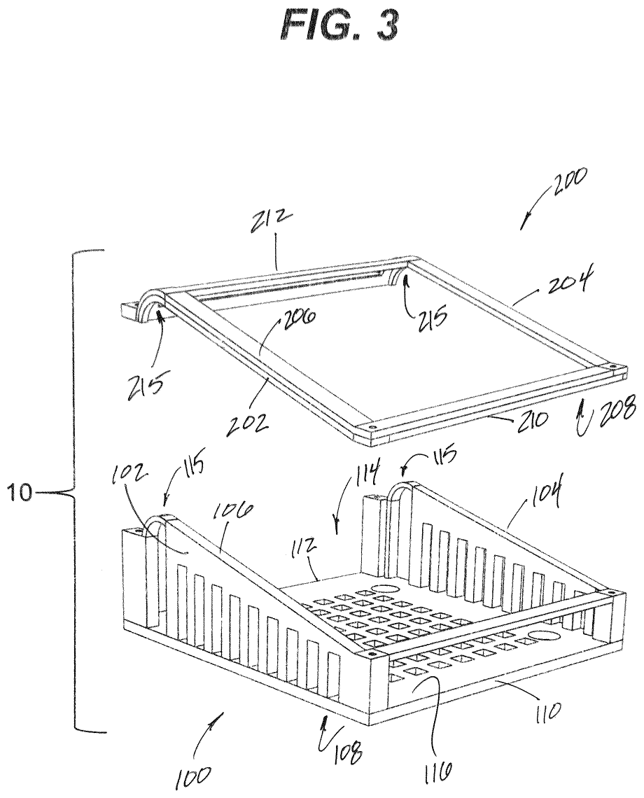

FIG. 1 shows a perspective view of an equipment holding and mounting assembly 10 (also referred to herein as simply the assembly 10), FIG. 2 shows side and top views of the assembly 10, and FIG. 3 shows an exploded view of the same.

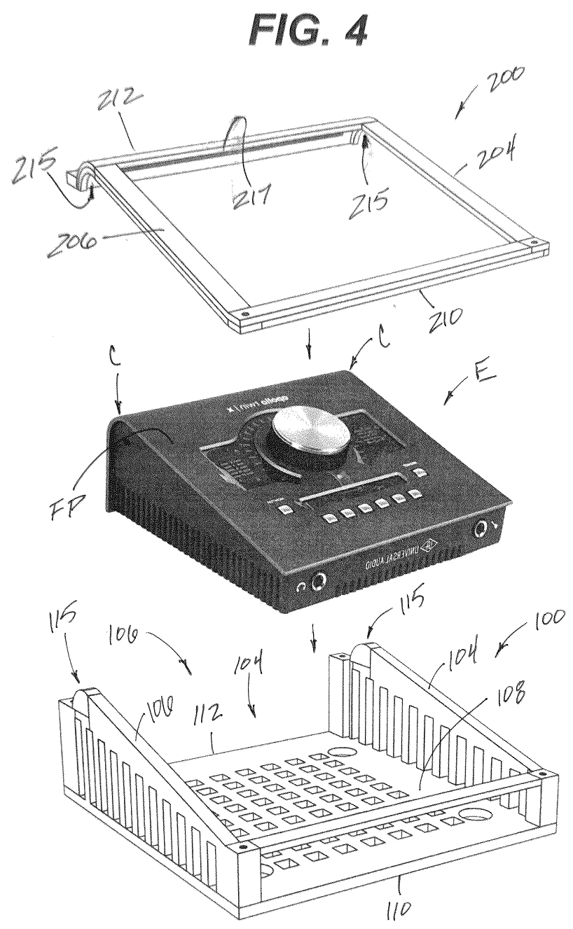

In some embodiments, as shown in FIGS. 1, 2, and 3, the equipment holding and mounting assembly 10 includes a base structure 100 and a containment structure 200. In general, the base structure 100 is designed to receive the electrical equipment E and to secure it in place (see FIG. 4), and the containment structure 200 is designed to secure the electrical equipment E therein. Mechanical hardware, e.g., bolts and nuts, may be configured with the base structure 100 to attach the base structure 100 to another structure, e.g., an equipment rack. The assembly 10 may include other elements as necessary for it to perform its functionalities as described herein.

For the purposes of this specification, the equipment holding and mounting assembly 10 will be described primarily with respect to its use in holding and mounting an Apollo Twin unit by Universal Audio. However, it is understood that the assembly 10 may be used to hold and mount other types of equipment E and that the scope of the assembly 10 is not limited in any way by the type of equipment that it is configured with to hold or to mount. It also is understood that different versions of the Apollo Twin and other types of equipment may be provided with different dimensions, forms, proportions, and/or footprints, that the assembly 10 may be used with any such versions, and that the scope of the assembly 10 is not limited in any way by the versions, dimensions, forms, proportions, and/or footprints of any equipment that it may be configured to hold and/or to mount.

In some embodiments, as shown in FIG. 3, the base structure 100 includes a left side 102, a right side 104, a top side 106, a bottom side 108, a front side 110, and a rear side 112, thereby defining an inner volume 114 with an inner bottom surface 116. As will be described in other sections, the base structure 100 may receive the electrical equipment E into its inner volume 114.

In some embodiments, as shown in FIG. 3, the containment structure 200 includes a left side 202, a right side 204, a top side 206, a bottom side 208, a front side 210, and a rear side 212. As will be described in other sections, with the equipment E received into the base structure 100, the containment structure's bottom side 208 may be configured (e.g., mated) with the base structure's top side 106 to secure the equipment E therein.

In some embodiments, as shown in FIG. 4, the electronic equipment E may be inserted into the base structure's inner volume 114 through its open top side 106. In this way, the bottom side of the equipment E may rest on the base structure's inner bottom surface 116. The containment structure 200 may then be mated and secured to the top of the base 100 to hold the equipment E therein.

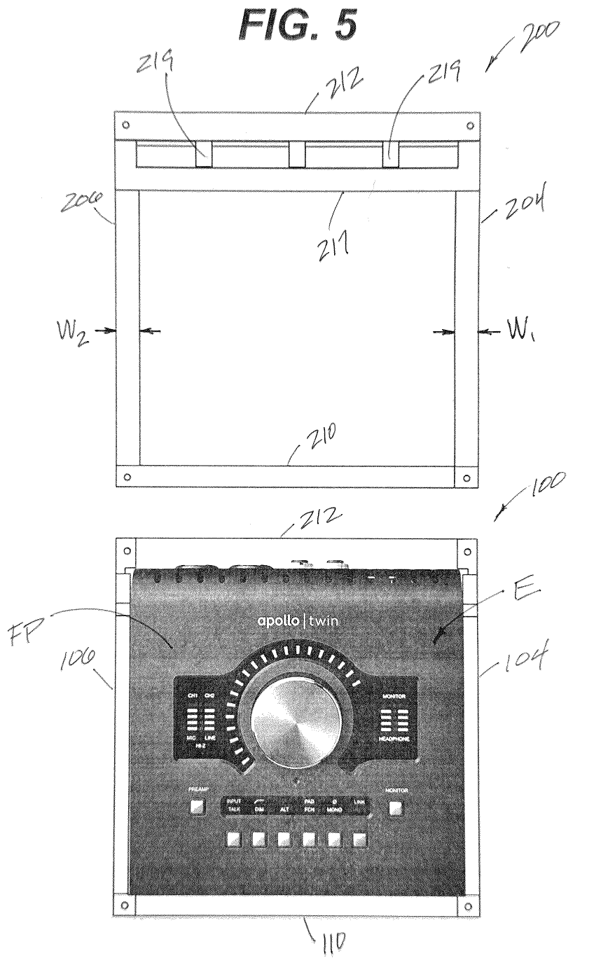

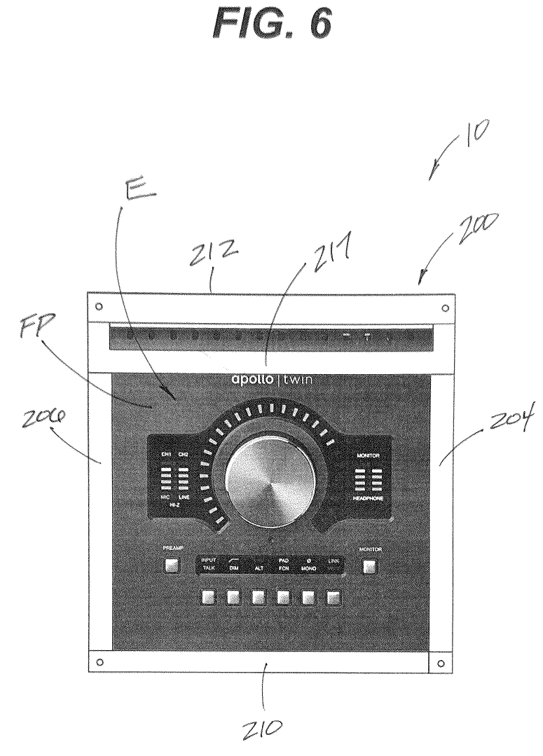

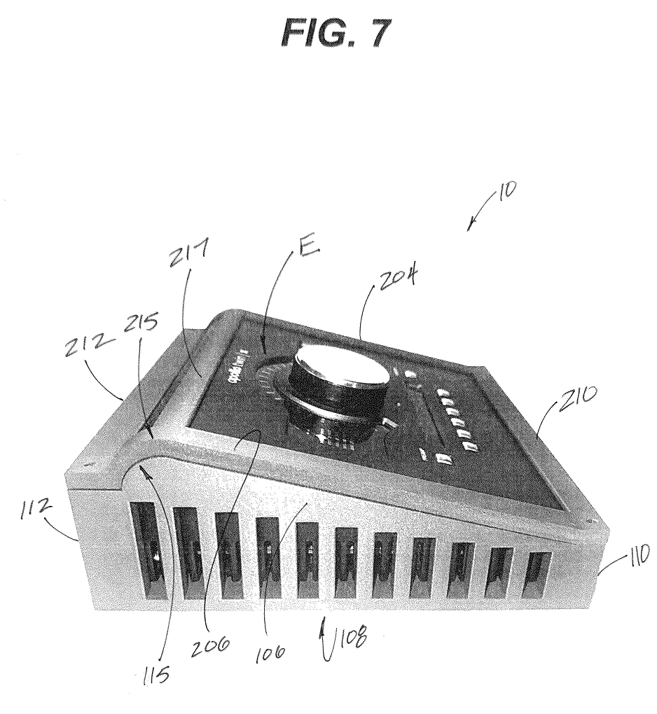

FIG. 5 shows a top view of the equipment E received into the base's inner volume 114 and resting on the base's inner bottom surface 116. FIG. 5 also shows a top view of the corresponding containment structure 200. FIG. 6 shows a top view of the assembly 10 and equipment E of FIG. 5 with the containment structure 200 attached to the top of the base 100, and FIG. 7 shows a perspective side view of the same.

In some embodiments, as shown in FIGS. 4-7, the containment structure 200 is designed to include a footprint that generally matches the footprint of the upper portion of the base structure 100 so that when the containment structure 200 is placed on top of the base structure 100, it may generally rest flush against the base structure's upper surface. As shown in FIGS. 4 and 7, the base's left and right sides 106, 104 may include an upward slope extending between the front 110 and back 112 of the base 100 that may preferably match the upward slope of the front panel FP of the equipment E. In addition, the base's sides 104, 106 also may each include a convex curvature 115 at or near the peak of the upward slope, e.g., towards the back 112 of the base 100, that preferably matches the convex curvature C of the equipment E in its corresponding portion (e.g., at or near the back of the equipment E).

In some embodiments, the containment structure 200 also may include sloping left and right sides 106, 104 that may correspond to the sloping left and right sides 106, 104 of the base 100. The containment structure 200 also may include a concave curvature 215 that corresponds to the convex curvature 115 of the base and the convex curvature C of the equipment E.

The matching slopes of the base's sides 104, 106, of the containment structure's sides 204, 206, and of the equipment's front panel FP are critical for the proper fitting of the equipment E within the base 100 and for the proper fitting of the containment structure 200 onto the base 100 such that gaps between the equipment E and the assembly 10 are minimizes for a snug and flush fit of the equipment E therein.

When the equipment E is received into the base 100, the upper surfaces of the base's sloping sides 104, 106 may generally correspond (e.g., be even or flush with) the equipment's front panel FP. The containment structure 200 may then be attached to base 100 and may rest flush against the base 100 and the equipment's front panel FP. As such, it is preferable that the front panel FP of the equipment E does not extend above the base's sides 104, 106 so that the containment structure 200 may rest flush against the sides 104, 106 and against the panel FP when mated. It also is preferable that the containment structure's left side 106, right side 104, front side 110, and back side 112 mate flush with the base's corresponding left side 106, right side 104, front side 110, and back side 112. The result of this is shown in FIGS. 6-7.

In some embodiments, as shown in FIG. 5, the sides 204, 206 of the containment structure 200 may include widths W1, W2, respectively, that are greater than the corresponding widths of the sides 104, 106, respectively, of the base 100. In this way, when the containment structure 200 is secured to the top of the base 100, inner portions of the containment structure's left and right sides 106, 104 may each extend into the open top area of the base 100 and over corresponding far-left and far-right portions of the equipment's front panel FP thereunder. It is preferable that these overlapping portions of the containment structure's left and right sides 106, 104 mate flush against the equipment's front panel FP in these areas to hold the equipment E snug. In some embodiments, the width W1 may match the width W2 but this may not be necessary depending on the form and mechanisms of the equipment's front panel FP.

In some embodiments, the containment structure's front 210 also may extend into the base's open top to overlap and rest flush against the equipment in this area when the containment structure 200 is mated with the base 100.

The result of the above-described arrangement is shown in FIGS. 6-7.

In some embodiments, as shown in FIGS. 5 and 6, the containment structure 200 may include an upper support beam 217 that extends from the structure's left side 106 to its right side 104 (or at least a portion(s) thereof). The support beam 217 may preferably rest flush against the equipment's front panel FP when mated such that the support beam 217 may provide further containment of the equipment E thereunder.

In some embodiments, the containment structure 200 may include one or more support beam connection members 219 extending from the support beam 217 to the rear portion or rear side 212 of the containment structure 200. In some embodiments, the connection members 219 may extend generally perpendicular to the support beam 217 and/or to the containment structure's rear side 212. Said connection members 219 may provide additional support to the support beam 217 and/or to the structure's rear side 212. In some embodiments, the connection members 219 may follow the same or similar curvature as the containment structure's concave curvature 215 so that the connection members 219 may rest flush against the upper surface of the equipment E in this area. While three connection members 219 are depicted in FIG. 5, it is understood that any number of connection members 219 may be used, that the connection members 219 need not match, and that the connection members need not be positioned symmetrically between the left and right sides 206, 204 depending on the configuration of the equipment's front panel FP.

While the support beam 217 and the connection members 219 are shown to be positioned at or near the structure's concave curvature 215 so as to not obstruct or interfere with mechanisms on the front panel FP, it is understood that the beam 217 (and/or a second support beam) may be positioned in other areas (that preferably do not interfere or obstruct mechanisms on the equipment's front panel FP). It also is understood that the beam 217 may include curvatures or other structural aspects and that the beam 217 may not necessarily be oriented perpendicular to the sides 204, 206 as depicted (although this may be preferable). The result of the above is shown in FIGS. 6-7. Note that FIGS. 6-7 do not depict the support beam connection members 219 as an alternative embodiment.

In some embodiments, the upper surface of the base's front 110 (and of its sides 104, 106 at or near the front 110) may be generally horizontal, and the lower surface of the containment structure's front 210 (and of its sides 204, 206 at or near the front 210) also may be generally horizontal. In this way, the interface between the base 100 and the containment structure 200 at this area also may be horizontal. Given this, attachment mechanisms, e.g., screws, pins, or bolts, may be inserted vertically through the containment structure 200 and into the base structure 100 in these areas to couple the structures 100, 200 together. For example, attachment mechanisms may be inserted in each of the left and right front corners of the containment structure 200 and base 100 to removably couple the structures 200, 100 together. This may enable a user to access the attachment mechanisms from above for insertion and/or removal of the mechanisms (e.g., to configure the equipment E with the assembly 10 or to remove it therefrom). Attachment mechanisms may be used in other locations as well.

Similarly, in some embodiments, the upper surfaces base's back 112 (and of its sides 104, 106 at or near the back) may be generally horizontal, and the lower surface of the containment structure's back 212 (and of its sides 204, 206 at or near the back 212) also may be generally horizontal. In this way, the interface between the base 100 and the containment structure 200 at this area also may be horizontal. Given this, attachment mechanisms, e.g., screws, pins, or bolts, may be inserted vertically through the containment structure 200 and into the base structure 100 in these areas to mate the structures 100, 200 together. For example, attachment mechanisms may be inserted in each of the left and right rear corners of the containment structure 200 and base 100 to removably couple the structures 200, 100 together. This may enable a user to access the attachment mechanisms from above for insertion and/or removal of the mechanisms (e.g., to configure the equipment E with the assembly 10 or to remove it therefrom). Attachment mechanisms may be used in other locations as well.

The result of the above-described arrangement is shown in FIGS. 6-7.

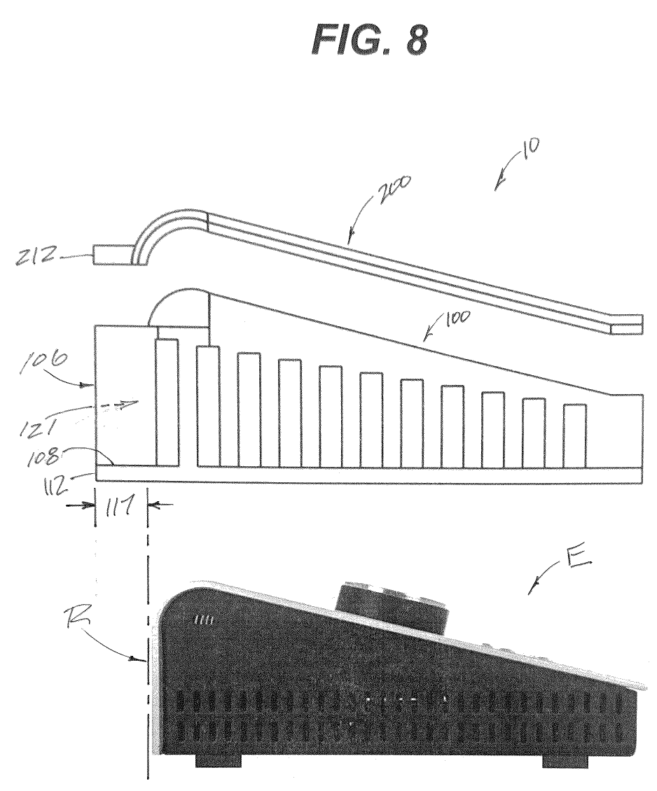

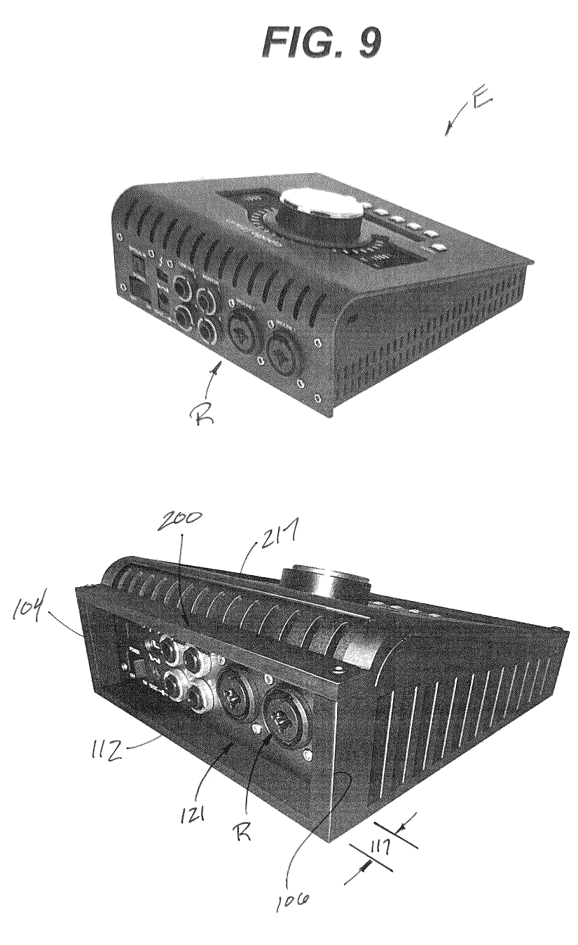

FIG. 8 shows a side view of the assembly 10 with the containment structure 200 aligned with but not attached to the base assembly 100. FIG. 8 also shows a corresponding side view of the equipment E aligned with the assembly 10. FIG. 9 shows a rear perspective view of the equipment E and a generally corresponding rear perspective view of the equipment E secured within the assembly 10.

In some embodiments, as shown in FIGS. 8-9, the equipment E may include interfaces, connectors, and/or other mechanisms on its back side R that may extend outward and away from the equipment's back side R and/or that may require mechanical shielding for protection. As such, the assembly 100 may provide a rear compartment for such mechanisms.

In some embodiments, as shown in FIGS. 8-9, when the equipment E when received into the assembly 10, the back side R of the equipment E may be positioned within the base's inner volume 114 and inset from the far back 112 of the base 100. This may leave a gap 117 between the back R of the equipment E and the back 112 of the base 100 thereby defining a compartment 121 behind the equipment E within the assembly 10. In addition, the base's sides 106, 104 and inner surface 108 may extend to the far back 112 thereby enclosing the compartment 121 on the left and right sides, and on the bottom, respectively. Also, the containment structure 200 may include a back 212 that extends between the left and right sides 106, 104 that may provide a top wall to the compartment 121. In this way, the compartment 121 may be enclosed on its left and right sides, on its bottom, and on its top. It may be preferable however that the compartment 121 be open to the back of the assembly 10 to provide access to the back R of the equipment E and the mechanisms thereon.

It is preferable that the dimensions of the compartment 121 be chosen to provide adequate room and protection to the mechanisms on the back R of the equipment E. For example, in some embodiments, the gap 117 may be about 0.1″ to about 1.0″, and preferably about 0.25″ to about 0.5″.

As shown in FIG. 4, it also may be preferable that the front 110 of the assembly 10 be open to provide access to the front side of the equipment E and to the interfaces and/or mechanisms thereon.

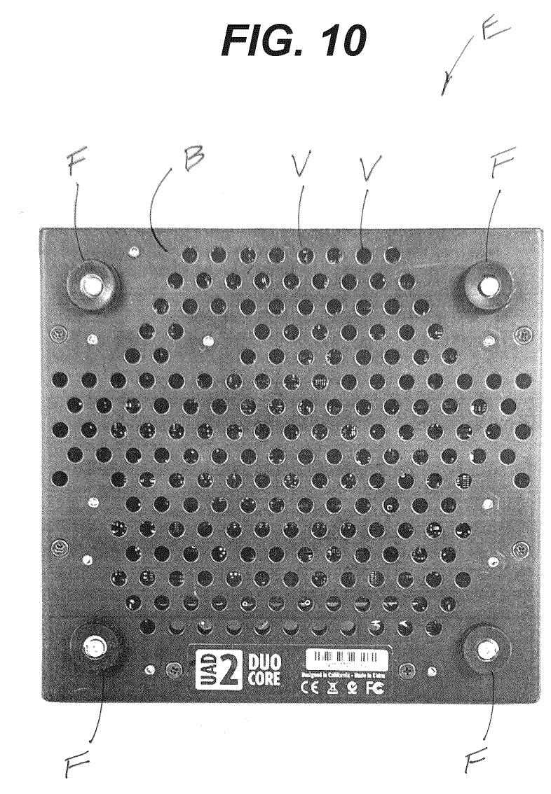

FIG. 10 shows a bottom view of an electrical equipment E including a bottom side B, bottom feet F, and bottom air vents V. The bottom feet F extend generally perpendicularly outward from the bottom side B a distance (e.g., about 0.25″) and are designed for the equipment to rest upon.

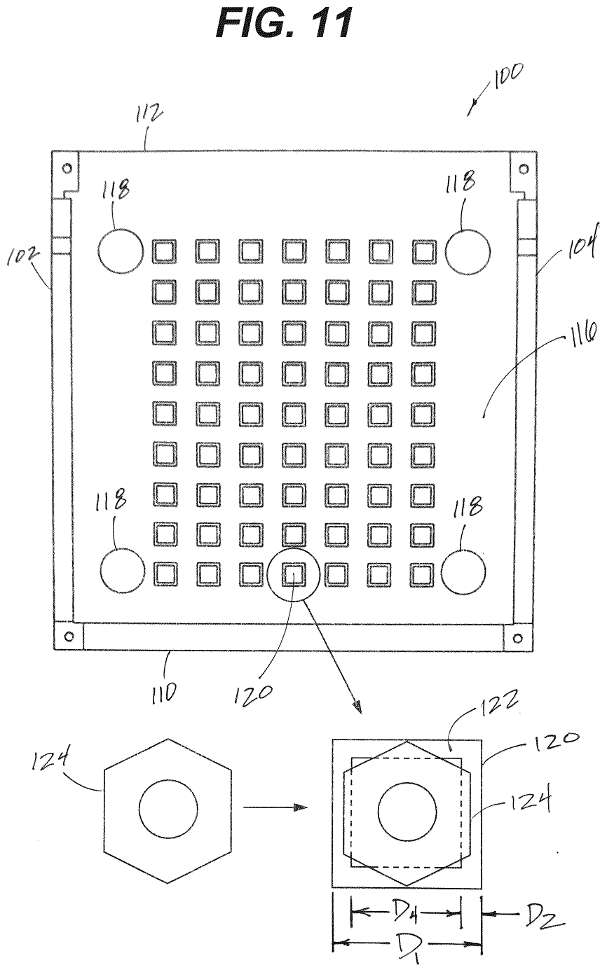

FIG. 11 shows a top view of the base structure 100 thereby showing the base structure's inner bottom surface 116.

In some embodiments, as shown in FIG. 11, the inner bottom surface 116 may include one or more feet receiving apertures 118 designed to receive the feet F of the electrical equipment E when the equipment E is placed into the base structure's inner volume 114. The feet receiving apertures 118 may preferably be sized, shaped, and positioned (e.g., in each corner) such that when the equipment E is placed into the base 100 each aperture 118 may receive a corresponding foot F. In some embodiments, each aperture 118 may receive an entire (or at least a portion and preferably a majority) of the height of a corresponding foot F. In this way, the bottom surface B of the equipment E may rest flush against (or close to) the base's bottom surface 116 when resting within the base's inner volume 114. This arrangement also may hold the equipment E in the proper position and orientation within and with respect to the base structure 100. While FIG. 11 shows the feet receiving apertures 118 as circular and arranged generally in each corner, it is understood that this is meant for demonstration and that the apertures 118 may be formed in any suitable shape and positioned according to any arrangement of feet on any piece of electronic equipment E to be supported.

As shown in FIG. 10, the equipment's bottom side B includes air vents V that allow air to pass into the equipment E for cooling purposes. However, the equipment E also includes a circuit board directly behind the vents V, such that the vents V cannot be used to receive screws or bolts to secure the equipment E to a rack, as the screws or bolts may easily make contact with the circuit board thereby potentially causing problems, e.g., electrical short circuiting.

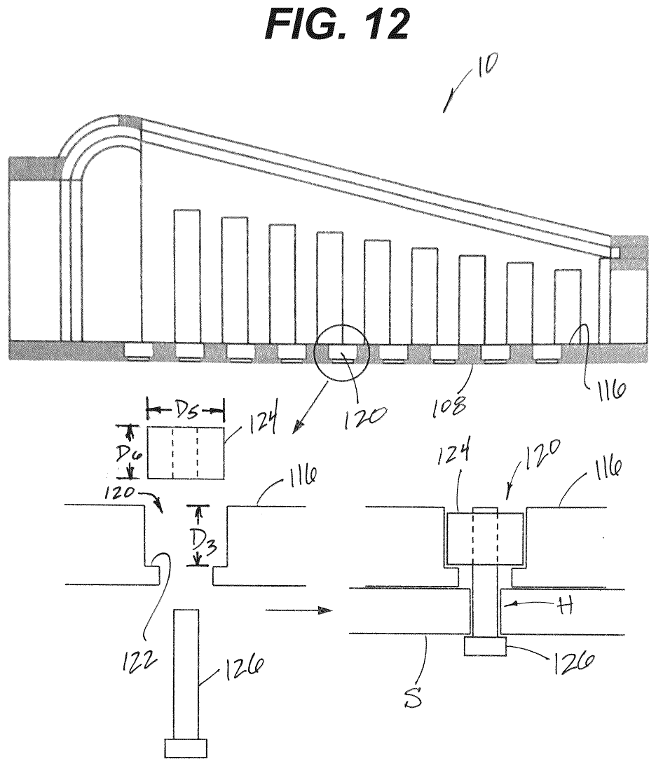

As such, in some embodiments, as shown in FIGS. 11 and 12, the base structure's inner bottom surface 116 includes one or more attachment apertures 120 that pass through the equipment's bottom side 108, and that may be used to secure the equipment E to the surface 116 (as described in other sections). In addition, in some embodiments, the bottom surface 116 includes a plurality of attachment apertures 120, e.g., arranged in a matrix of rows and columns that may generally align with the rows and columns of air vents V on the bottom B of the equipment E. In this way, the attachment apertures 120 also may allow air to pass through the bottom surface 116 (through the apertures 120) and the equipment's air vents V to provide cooling to the equipment E.

In some embodiments, as shown in FIGS. 11 and 12, each attachment aperture 120 may have an upper width D1. In addition, each aperture 120 may include an inner circumferential ledge 122 extending inward a distance D2 from a respective sidewall of the aperture 120 towards the center of the aperture 120 and spaced a distance D3 from the open top of the aperture 120. It may be preferable that each ledge 122 extend about the entire inner circumference of the respective aperture 120, or at least an adequate portion thereof as described in other sections. Given the above, each aperture 120 may include a lower opening with width D4 (wherein D1=D2+D4+D2).

While the apertures 120 of FIG. 11 are depicted as generally square shaped, it is understood that this is for demonstration and that the apertures 120 may be formed as other shapes, e.g., as polygonal shapes.

In some embodiments, the assembly 10 includes one or more attachment mechanisms 124 that may be inserted into the top of a corresponding aperture 120 and be held within the aperture 120 by the corresponding circumferential ledge 122. That is, an attachment mechanism 124 may be inserted into an aperture 120 and may rest on the top of the corresponding ledge 122 within the aperture 120. The attachment mechanisms 124 may include widths D5 and heights D6.

As shown in FIGS. 11 and 12, it may be preferable that the attachment mechanism's width D5 be less than the corresponding attachment aperture's upper opening width D1 but greater than the aperture's lower opening width D4. In this way, the attachment mechanism 124 may be inserted into the corresponding aperture 120 from the top and may rest upon the aperture's inner ledge 122 therein. Also, it may be preferable that the height D6 of each attachment mechanism 124 be less than or equal to the distance D3 between the top of the corresponding aperture 120 and the aperture's inner ledge 122. In this way, the attachment mechanism 124 may rest within the corresponding aperture 120 with its top side flush or below the top side of the aperture 120 (e.g., the base's inner bottom surface 116) as shown.

In some embodiments, each attachment mechanism 124 may include a nut 124 designed to receive an associated bolt 126.

As shown in FIG. 12, the assembly 10 may be secured to another surface S (e.g., a shelf within an equipment rack) that may include a corresponding surface aperture H. In some embodiments, the bottom 108 of the assembly 10 may be placed onto the surface S (preferably flush) with the surface's aperture H aligned with the assembly's attachment aperture 120. The attachment mechanism 124, e.g., the nut 124, may be configured with the assembly's attachment aperture 120 as described above and the bolt 126 may be arranged to pass through the surface's aperture H from the bottom. The bolt 126 may pass through the surface's aperture H and through the attachment aperture's lower opening to engage (e.g., screw into) the nut 124). Once tightened, the bolt 126 may be threadedly mated with the corresponding nut 124 to hold the bottom 108 of the assembly 10 tight against the surface S. It may be preferable that the length of the bolt 126 be chosen such that when the bolt 126 is adequately engaged with the nut 124 that the distal end of the bolt 126 be flush or below the top of the attachment aperture 120 (e.g., flush or below the base's inner bottom surface 116). In this way, the bolt 126 may not engage with the bottom B of the equipment E.

In some embodiments, it may be preferable that the width D1 of the attachment aperture 120 be chosen such that when the attachment mechanism 124 (e.g., the nut 124) is configured to rest upon the aperture's inner ledge 122, that the attachment mechanism 124 be lodged therein and be prevented from rotating about its vertical axis. In this way, as the bolt 126 is screwed into the nut 124, the nut 124 may be held in place to facilitate the threaded engagement. However, the ledge 122 may be formed with an adequate friction coefficient on its upper surface such that the friction between the ledge 122 and the nut 124 may be adequate to hold the nut 124 in place, especially as it becomes tightened.

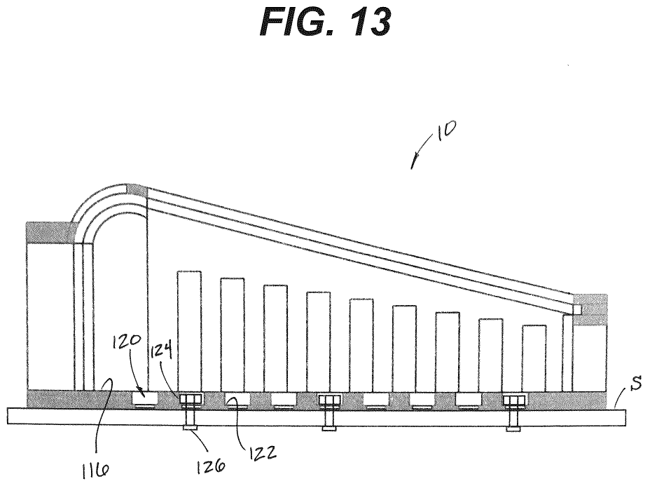

FIG. 13 depicts the assembly 10 secured to the surface S as described above.

It is understood that other types of attachment mechanisms 124 also may be configured with the attachment aperture 120 and the associated surface S to attach the assembly 10 to the surface S, e.g., the attachment mechanisms 124 may include rivets, snaps, posts and detents, screws, latches, etc.

In addition, it also is understood that the relative position of the nut 124 and the bolt 126 may be reversed, that is, the bolt 126 may be inserted into the attachment aperture 120 from above such that its head rests upon the attachment aperture's inner ledge 122 and the nut 124 may be engaged with the bolt 126 from underneath the surface S. In this case, it is preferable that the width and height of the bolt's head be sized in the same or similar fashion as the width D5 and height D6 of the nut 124 as described in other sections.

As described above, the attachment mechanisms 124, 126 are preferably accessible from above the base's bottom inner surface 116 and/or from below the underneath side of the associated surface S (e.g., the shelf or rack) so that the assembly 10 may be easily attached and detached from the surface S.

It is understood that any aspect and/or element of any embodiment of the assembly 10 described herein or otherwise may be combined in any way with any other aspect and/or element of any other embodiment of the assembly 10 to form additional embodiments of the assembly 10 all of which are within the scope of the assembly 10.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and / or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent, or similar purpose can replace features disclosed in the specification, unless stated otherwise. Thus, unless stated otherwise, each feature disclosed represents one example of a generic series of equivalent or similar features.

The present invention also covers the exact terms, features, values, and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

1. An equipment holder comprising:
a base including an upper surface and a lower surface opposite the upper surface, a base front end, a base rear end, a base left side, and a base right side;
a first sidewall coupled to the left side of the base and a second sidewall coupled to the right side of the base, the first and second sidewalls extending upward and perpendicular to the upper surface of the base;
a containment structure attachable to a first top side of the first sidewall and to a second top side of the second sidewall;
a first aperture including first aperture sidewalls passing through the base from the upper surface to the lower surface and including a first inner ledge extending inward from the first aperture sidewalls and located at an sidewalls intermediate location between the upper surface and the lower surface;
a first attachment mechanism positioned within the first aperture and resting on the first inner ledge, and a second attachment mechanism configurable to extend into the first aperture from the lower surface of the base and to releasably connect to the first attachment mechanism;
wherein the second attachment mechanism includes a length chosen to enable a surface of a separate structure to be positioned against the lower surface of the base and to be held thereto by the second attachment mechanism.

2. The equipment holder of claim 1 wherein the first attachment mechanism includes a nut and the second attachment mechanism incudes a bolt.

3. The equipment holder of claim 1 wherein the first inner ledge includes an inner circumferential ledge extending at least partially about an inner circumference of the first aperture.

4. The equipment holder of claim 1 where in the first aperture sidewalls restrict rotational movement of the first attachment mechanism.

5. The equipment holder of claim 1 wherein the first aperture includes a square cross-section.

6. The equipment holder of claim 1 wherein an uppermost top surface of the first attachment mechanism is at or below the upper surface of the base.

7. The equipment holder of claim 1 wherein the containment structure includes a structure left side, a structure right side, a structure front side, a structure rear side, and an interior portion defined by the structure left side, structure right side, structure front side, and structure rear side, wherein at least a portion of the interior portion is open.

8. The equipment holder of claim 7 wherein the first sidewall includes a first horizonal portion aligned with the front end of the base and a second horizonal portion aligned with the rear end of the base, and the second sidewall includes a third horizontal portion aligned with the front end of the base and a fourth horizontal portion aligned with the rear end of the base.

9. The equipment holder of claim 8 wherein the first horizontal portion includes a first height, and the second horizontal portion includes a second height, and the second height is greater than the first height, and the third horizontal portion includes a third height, and the fourth horizontal portion includes a fourth height, and the fourth height is greater than the third height.

10. The equipment holder of claim 9 wherein the first height matches the third height, and the second height matches the fourth height.

11. The equipment holder of claim 10 wherein the containment structure includes a fifth horizontal portion that corresponds to the first horizontal portion of the first sidewall and to the third horizontal portion of the second sidewall when the containment structure is attached to the first top side of the first sidewall and to the second top side of the second sidewall, and a sixth horizontal portion that corresponds to the second horizontal portion of the first sidewall and to the fourth horizontal portion of the second sidewall when the containment structure is attached to the first top side of the first sidewall and to the second top side of the second sidewall.

12. The equipment holder of claim 11 wherein the first horizontal portion and/or the third horizontal portion include a first attachment mechanism adapted to releasably attach the fifth horizontal portion of the containment structure to the first and second sidewalls.

13. The equipment holder of claim 11 wherein the second horizontal portion and/or the fourth horizontal portion include a second attachment mechanism adapted to releasably attach the fifth horizontal portion of the containment structure to the first and second sidewalls.

14. The equipment holder of claim 11 wherein the containment structure extends, when releasably attached to the first top side of the first sidewall and to a second top side of the second sidewall, linearly from its fifth horizontal portion to an intermediate location between the fifth horizontal portion and the sixth horizontal portion.

15. The equipment holder of claim 14 wherein a fifth height of the containment structure at the intermediate location is greater than the second height and the fourth height.

16. The equipment holder of claim 15 wherein the containment structure includes an upper curvature extending from the intermediate location to the sixth horizontal portion.

17. The equipment holder of claim 11 wherein the containment structure includes a support beam extending from the structure left side to the structure right side at the intermediate location.

18. The equipment holder of claim 11 wherein when the containment structure is attached to the first top side of the first sidewall and to the second top side of the second sidewall the base rear end, the first sidewall at the second horizontal portion, the second sidewall at the fourth horizontal portion, and the structure rear side form an open cuboid.
